(19) United States
(12) Patent Application Publication
(10) Pub. No.: US 2020/0303887 A1
(43) Pub. Date: Sep. 24, 2020

(54) ELECTRONIC COUPLER REMOVAL TOOL

(71) Applicant: Honda Motor Co., Ltd., Tokyo (JP)

(72) Inventors: Bryan Scott Draughon, Marysville, OH (US); Carlos Andres Neyra Rocha, Hilliard, OH (US); Alicia Marie Eleyet, West Mansfield, OH (US); Joseph Patrick Derr, Marysville, OH (US)

(21) Appl. No.: 16/361,113

(22) Filed: Mar. 21, 2019

(51) Int. Cl. H01R 43/26; B25B 27/14

(52) U.S. Cl. CPC H01R 43/26; H01R 13/627; B25B 27/14

(57) ABSTRACT

An electronic coupler removal tool which includes a first wall, a second wall, a third wall, and a tab engaging portion is provided. The first wall includes a first end and a second end. The second wall is positioned at the first end and extends perpendicularly from the first end of the first wall. The third wall is positioned at the second end and extends substantially perpendicularly from the second end of the first wall. The first wall, the second wall, and the third wall partially define an electronic coupler-receiving portion configured to receive an electronic coupler. The tab engaging portion extends substantially perpendicularly from at least one of the first wall and the second wall and is configured to engage a locking tab of the electronic coupler when the electronic coupler is positioned in the electronic coupler-receiving portion.

### BACKGROUND

Electronic couplers are used to connect networking cables that transmit and/or receive electronic signals to different communication ports of a vehicle's network. These electronic couplers are used within the vehicle's wired networks to connect various circuit board ports provided in several vehicle electronic systems, such as global navigation satellite systems (GNSS), rear entertainment systems (RES), air bag systems, infotainment systems, and assorted multimedia devices. Typically, a locking tab may be provided to secure individual electronic couplers within individual circuit board ports when individual electronic couplers are inserted into the corresponding circuit board ports. The electronic couplers may be held in place using the locking tab which may be retained in a groove provided in a corresponding circuit board port.

In order to unplug or remove the electronic coupler from a circuit board port, the locking tab may have to be carefully released from the locked state. This may require a pressing of the locking tab in a specific direction. As the form factor of the locking tab is small, a push force on the locking tab may sometimes be applied in an undesired direction or may remain inadequate for a finger-assisted release of the locking tab. This may prevent a full disengagement of the locking tab from the circuit board port. In some cases, an operator may have to handle the electronic coupler carefully once the locking tab is released to prevent damage to the wire attached to the electronic coupler.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An exemplary aspect of the disclosure provides an electronic coupler removal tool. The electronic coupler may include a first wall, a second wall, a third wall, and a tab engaging portion. The first wall may include a first end and a second end. The second wall may be positioned at the first end of the first wall and may extend perpendicularly from the first end of the first wall. The third wall positioned at the second end of the first wall may extend substantially perpendicularly from the second end of the first wall. The first wall, second wall and the third wall may partially define an electronic coupler-receiving portion that may be configured to slidably receive an electronic coupler. Further, the tab engaging portion may extend substantially perpendicularly from the second wall and may be configured to engage with a locking tab of the electronic coupler when the electronic coupler is positioned at least partially within the electronic coupler-receiving portion.

Another exemplary aspect of the disclosure provides a method for removal of an electronic coupler. In the exemplary method, an electronic coupler removal tool is provided. The electronic coupler may include a first wall, a second wall, a third wall, and a tab engaging portion. The first wall may include a first end and a second end. The second wall may be positioned at the first end of the first wall and may extend perpendicularly from the first end of the first wall. The third wall positioned at the second end of the first wall may extend substantially perpendicularly from the second end of the first wall. The first wall, second wall and the third wall may partially define an electronic coupler-receiving portion that may be configured to slidably receive an electronic coupler. Further, the tab engaging portion may extend substantially perpendicularly from the second wall and may be configured to engage with a locking tab of the electronic coupler when the electronic coupler is positioned at least partially within the electronic coupler-receiving portion. Further, in the exemplary method, the electronic coupler-receiving portion may be coaxially aligned with the electronic coupler mounted on a circuit board. The electronic coupler-receiving portion may slide over an exterior profile of the electronic coupler such that the tab engaging portion contacts with the electronic coupler. Thereafter, the electronic coupler may be restrained within the electronic coupler-receiving portion via the tab engaging portion and the electronic coupler-receiving portion may be maneuvered to remove the restrained electronic coupler from the circuit board.

This summary is provided to introduce a selection of concepts in a simplified form that are further disclosed in the detailed description of the present disclosure. This summary is not intended to identify key or essential inventive concepts of the claimed subject matter, nor is it intended for determining the scope of the claimed subject matter.

### BRIEF DESCRIPTION OF THE DRAWINGS

FIG. 1 illustrates a perspective view of an electronic coupler removal tool, in accordance with a first embodiment of the disclosure.

FIGS. 2a, 2b, and 2c, collectively, illustrate an exemplary sequence of operations for removal of an electronic coupler using the electronic coupler removal tool of FIG. 1.

FIGS. 3a and 3b illustrate an alternative embodiment of the electronic coupler removal tool shown in FIG. 1.

FIG. 4 illustrates a perspective view of an electronic coupler removal tool, in accordance with a second embodiment of the disclosure.

FIG. 5 illustrates a perspective view of an alternative embodiment of the electronic coupler removal tool shown in FIG. 4.

FIGS. 6a, 6b, and 6c, collectively, illustrate an exemplary sequence of operations performed using the electronic coupler removal tool of FIG. 4 for removal of an electronic coupler from a circuit board port.

FIG. 7 is a flowchart that illustrates an exemplary method for removal of an electronic coupler from a circuit board using an electronic coupler removal tool, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The present disclosure relates to an electronic coupler removal tool for removal of an electronic coupler from a circuit board. The disclosed electronic coupler removal tool aims to prevent damage to a body of the electronic coupler during removal of the electronic coupler from a corresponding circuit board port. The disclosed electronic coupler removal tool further aims to prevent damage to a cable attached to the electronic coupler. Moreover, the disclosed electronic coupler removal tool aims to prevent damage to the circuit board and/or circuit board port during removal of the electronic coupler. For example, if a user is unable to fully disengage the locking tab with their fingers, yet still attempts to remove the electronic coupler from the circuit board port, damage to the circuit board port, circuit board, and/or electronic coupler may occur. The disclosed electronic coupler removal tool includes a tab engaging portion to help an operator to securely disengage a locking tab of the electronic coupler. Also, the disclosed electronic coupler removal tool includes an electronic coupler-receiving portion that supports the electronic coupler along with the cable during removal of the electronic coupler from the corresponding circuit board port. The electronic coupler removal tool facilitates applying a force needed to fully disengage the locking tab. Notably, the electronic coupler removal tool is configured to apply the force needed to fully disengage the locking tab even when the locking tab is positioned in a manner that makes it difficult or nearly impossible to disengage with only the user's fingers.

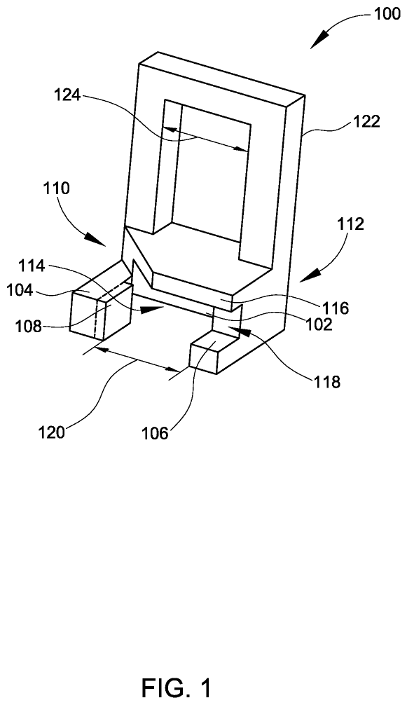

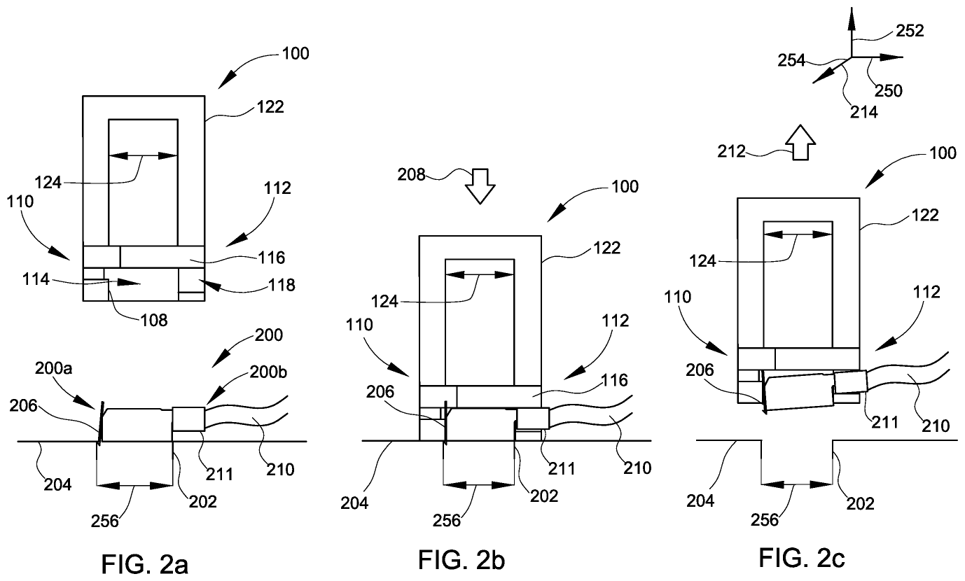

FIG. 1 illustrates a perspective view of an exemplary embodiment of an electronic coupler removal tool, referred to hereinafter as first electronic coupler removal tool 100. In the exemplary embodiment, the electronic coupler removal tool 100 is configured to facilitate removal of a right-angled electronic coupler, for example, an electronic coupler 200 (shown in FIGS. 2a, 2b, and 2c). The electronic coupler removal tool 100 may include a first wall 102, a second wall 104, a third wall 106, and a tab engaging portion 108. The first wall 102 may include a first end 110 and a second end 112. The second wall 104 may extend perpendicularly from the first end 110 of the first wall 102 and the third wall 106 may extend perpendicularly from the second end 112 of the first wall 102. The first wall 102, the second wall 104, and the third wall 106 may be attached with each other. The first wall 102, the second wall 104, and the third wall 106 may at least partially define an electronic coupler-receiving portion 114. The electronic coupler-receiving portion 114 may be configured to slidably receive an electronic coupler. The electronic coupler-receiving portion 114 may have a C-channel shape that may accommodate and securely hold the electronic coupler plugged into a communication port on a circuit board (see FIGS. 2a, 2b, and 2c). In some embodiments, the electronic coupler-receiving portion 114 may partially accommodate the electronic coupler used in different in-vehicle communication systems. As an example, the different in-vehicle communication systems may be one of an in-vehicle entertainment system, an in-vehicle infotainment system, or in-vehicle radio frequency (RF) communication system, or a navigation system that may implement a Global Navigation Satellite System (GNSS) receiver.

The tab engaging portion 108 may extend substantially perpendicular from the second wall 104. The tab engaging portion 108 may be configured to engage with a locking tab 206 (see FIGS. 2a, 2b, and 2c) of the electronic coupler when the electronic coupler is positioned at least partially within the electronic coupler-receiving portion 114. In cases where the electronic coupler is held within the electronic coupler-receiving portion 114, the tab engaging portion 108 may contact the locking tab and may be maneuvered to release the locking tab from a locked state to an unlocked state.

In accordance with an embodiment, the electronic coupler removal tool 100 may further include a stopper wall 116. The stopper wall 116 may extend substantially perpendicular from at least the first wall 102, the second wall 104, and the third wall 106. The stopper wall 116 may be configured to facilitate positioning of the electronic coupler within the electronic coupler-receiving portion 114. The stopper wall 116 may be of a suitable strength and shape to provide an adequate support for removal of the electronic coupler, without causing any damage to a cable and/or the electronic coupler. The stopper wall 116 and the third wall 106 may be carefully placed to leave an adequate clearance in order to accommodate different electronic couplers whose sizes vary within a certain size range. In certain embodiments, the stopper wall 116 and the third wall 106 may be carefully placed to provide an interference fit with an outer profile of the electronic coupler.

In accordance with an embodiment, the electronic coupler removal tool 100 may further include a cable support portion 118. The cable support portion 118 may be defined at least by the third wall 106 and the stopper wall 116. The cable support portion 118 may be configured to receive a cable attached to the electronic coupler and may partially enclose and support the cable.

The tab engaging portion 108 and the cable support portion 118 may be separated by a distance 120. The distance 120 may be same as that between the tab engaging portion 108 and the third wall 106. The distance 120 may determine a maximum size of the electronic coupler that may be accommodated within the electronic coupler-receiving portion 114. The cable support portion 118 defined by the stopper wall 116 and the third wall 106 may help to lift the electronic coupler once the tab engaging portion 108 disengages the locking tab, which is usually provided in the electronic coupler for a secure connection into the circuit board port. The electronic coupler may be one of a right-angled electronic coupler, a straight-angled electronic coupler, or a double straight-angled electronic coupler.

In some embodiments, the electronic coupler removal tool 100 may further include a handle 122 that may extend from the first wall 102. The handle 122 may be configured to maneuver the electronic coupler (restrained in a circuit board port) for removal from the corresponding circuit board port. The handle 122 may be a C-shaped handle that has a gap 124 that allows one or more fingers to slide in the gap 124 and lift the electronic coupler removal tool 100. An operator may use their fingers or a suitable tool within the gap 124 to grab onto the handle 122 and remove the electronic coupler from the circuit board port.

FIGS. 2a, 2b, and 2c, collectively, illustrate a sequence of operations for removal of an electronic coupler by the electronic coupler removal tool of FIG. 1, in accordance with an embodiment of the disclosure. The following description may be explained in conjunction with the drawing and detailed description of FIG. 1. With reference to FIGS. 2a, 2b, and 2c, there is shown a sequence of operations performed using the electronic coupler removal tool 100 for removal of an electronic coupler 200 from a circuit board port 202. In FIGS. 2a, 2b, and 2c, the electronic coupler 200 is a right-angled electronic coupler that has a specific design. However, the disclosure may not be so limited and in some embodiments, the design of the electronic coupler 200 may be different from the one that has been illustrated in FIGS. 2a, 2b, and 2c, without a deviation from scope of the disclosure.

With reference to FIG. 2a, the electronic coupler 200 may be typically installed within the circuit board port 202 of a circuit board 204. The circuit board port 202 may correspond to a communication port for an in-vehicle network and/or a vehicle-to-everything (V2X) communication network. Examples of the electronic coupler 200 may include, but are not limited to, a Media Oriented Systems Transport (MOST) bus coupler, a rear entertainment system (RES) coupler, and/or a Fakra connector.

The electronic coupler 200 may be plugged and locked into the circuit board port 202 provided on the circuit board 204 using a locking tab 206 coupled to the electronic coupler 200. The locking tab 206 may be made up of the same or different material as that of the electronic coupler 200. Alternatively, the locking tab 206 may be made up of a composite material with a metal center or other strengthening members. Initially when the electronic coupler 200 is plugged into the circuit board port 202, the locking tab 206 may be biased in a locked state and may be configured to secure the electronic coupler 200 to the corresponding circuit board port 202 when in the locked state. The tab engaging portion 108 and the cable support portion 118 may be separated by the distance 120. The distance 120 may be same as that between the second wall 104 and the third wall 106 and may correspond to a size of the electronic coupler 200. In order to remove the electronic coupler 200 from the circuit board port 202, the locking tab 206 may be need to be released from an initial locked state to an unlocked state. Also, a pulling maneuver may need to be applied in a specific direction to disengage the electronic coupler 200 from the circuit board port 202.

With reference to FIG. 2b, there is shown a maneuver to place the electronic coupler removal tool 100 such that the electronic coupler 200 is at least partially held within the electronic coupler-receiving portion 114 of the electronic coupler removal tool 100. In some embodiments, the electronic coupler 200 may include a first coupler end 200a having a first size and a second coupler end 200b having a second size. The first size may be different from the second size. The electronic coupler-receiving portion 114 is configured to engage with the electronic coupler 200 at the first coupler end 200a and the second coupler end 200b.

Movement of electronic coupler removal tool 100 is described with respect to an x-axis 250, a y-axis 252, and a z-axis 254 (i.e., z-axis is into and out of the page with regards to FIGS. 2a, 2b, and 2c). A downward motion of the electronic coupler removal tool 100 along y-axis 252 toward the circuit board 204 is referred to as movement in a first direction 208. An upward motion of the electronic coupler removal tool 100 along y-axis 252 away from the circuit board 204 is referred to as movement in a second direction 212. Movement of the electronic coupler removal tool 100 along z-axis 254 out of the page with respect to FIGS. 2a, 2b, and 2c is referred to as movement in a third direction 214. In the exemplary embodiment, the electronic coupler 200 is coupled to a cable 210, for example, at a connection point 211.

To remove the electronic coupler 200 from the circuit board port 202, the electronic coupler 200 is positioned at least partially within the electronic coupler-receiving portion 114. To achieve this, the tab engaging portion 108 is positioned against the locking tab 206. Then, in order to position cable 210 and/or connection point 211 at least partially within cable support portion 118, at least a portion of the electronic coupler removal tool 100 is moved in the third direction 214. Alternatively, or in combination with the motion in the third direction 214, the electronic coupler 200 may be rotated around y-axis 252 in order to position cable 210 and/or connection point 211 at least partially within cable support portion 118. Additionally, second wall 104 may function as a cable support portion for electronic couplers oriented such that the cable is coupled to first cable end 200a rather than second cable end 200b. The electronic coupler-receiving portion 114 may be shaped to conform to the exterior profile of the electronic coupler 200. More specifically, a width 256 of the electronic coupler 200 is substantially similar, although slightly smaller, than distance 120. Therefore, when the electronic coupler 200 is positioned within the electronic coupler-receiving portion 114, locking tab 206 is held in an unlocked state. Typically, the circuit board port 202 includes a groove to receive the locking tab 206. For example, the groove may be a recessed provision adapted to receive the locking tab 206 and to prevent removal of the locking tab 206 when the locking tab 206 is in the locked state.

With reference to FIG. 2c, there is shown a maneuver performed using the electronic coupler removal tool 100 to remove the restrained electronic coupler 200 from the circuit board port 202. This maneuver may be performed once the electronic coupler 200 is positioned at least partially within the electronic coupler-receiving portion 114 and locking tab 206 is released from the circuit board port 202 (i.e., is in the unlocked state). For the maneuver, the electronic coupler removal tool 100 may be rotated around x-axis 250 by pushing on handle 122 in a direction opposite to third direction 214 (i.e., into-the page with respect to FIG. 2c) to begin removal of the electronic coupler 200 from circuit board port 202. The rotation may help the cable support portion 118 to lift up cable 210 attached to the electronic coupler 200 and thereby slightly disengage the electronic coupler 200 from the circuit board port 202. In order to completely remove the restrained electronic coupler 200 from the circuit board port 202, the electronic coupler removal tool 100 is pulled in second direction 212 relative to the circuit board port 202 to remove the electronic coupler 200 from the circuit board port 202.

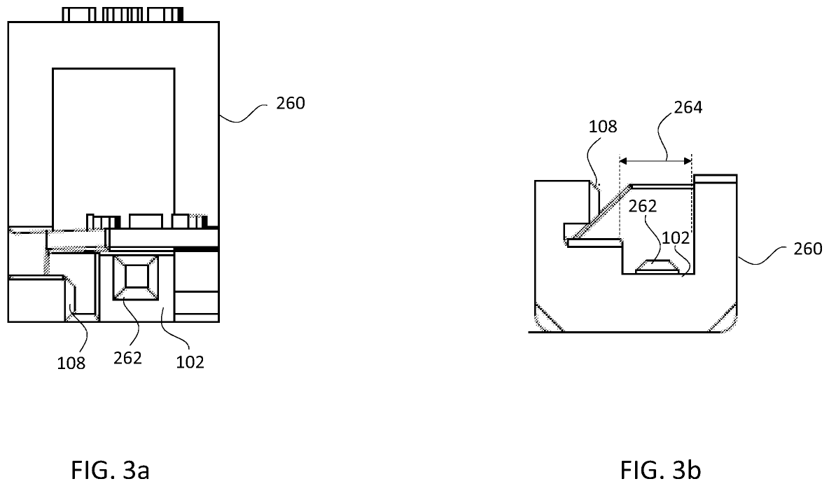

FIGS. 3a and 3b illustrate an alternative embodiment 260 of the electronic coupler removal tool 100 (shown in FIG. 1). More specifically, FIG. 3a is a front view of the electronic coupler removal tool 260 and FIG. 3b is a bottom view of the electronic coupler removal tool 260. The electronic coupler removal tool 260 includes a first tab engaging portion, for example, tab engaging portion 108 (also shown in FIG. 1), and a second tab engaging portion 262. In this embodiment, second tab engaging portion 262 extends from the first wall 102. The electronic coupler removal tool 260 functions in substantially the same manner as the electronic coupler removal tool 100, however, the electronic coupler removal tool 260 is capable of removing additional electronic couplers in addition to the electronic coupler 200 shown in FIGS. 2a, 2b, and 2c. For example, the electronic coupler removal tool 260 can remove a right-angled electronic coupler having a width approximate to, but slightly smaller than a distance 264 and a locking tab positioned on a rear side of the electronic coupler (i.e., on a side of the electronic coupler adjacent to tab engaging portion 262 when electronic coupler removal tool 260 is in use).

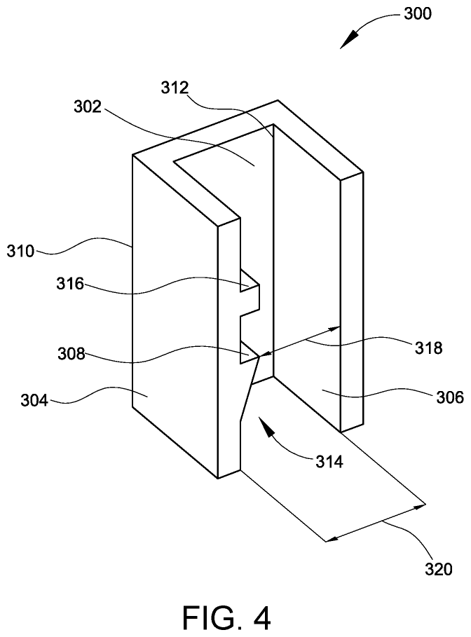

FIG. 4 illustrates a perspective view of an alternative embodiment of an electronic coupler removal tool, referred to hereinafter as second electronic coupler removal tool 300. The second electronic coupler removal tool 300 may be different from the first electronic coupler removal tool 100. More specifically, the second electronic coupler removal tool 300 may be suitable for removal of a straight electronic coupler or a double straight electronic coupler (e.g., two straight electronic couplers positioned adjacent each other).

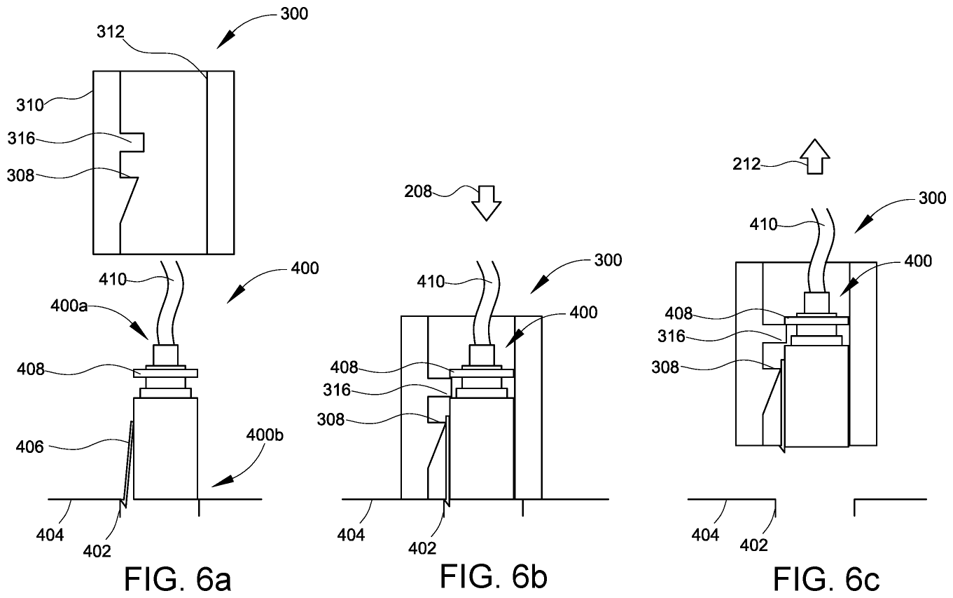

The electronic coupler removal tool 300 may include a first wall 302, a second wall 304, a third wall 306, and a tab engaging portion 308. The first wall 302 may include a first end 310 and a second end 312. The second wall 304 may extend substantially perpendicular from the first end 310 of the first wall 302 and the third wall 306 may extend substantially perpendicular from the second end 312 of the first wall 302. The first wall 302, the second wall 304, and the third wall 306 may be joined with each other. The first wall 302, the second wall 304, and the third wall 306 may at least partially define an electronic coupler-receiving portion 314. The electronic coupler-receiving portion 314 may be configured to slidably receive an electronic coupler. An example of the electronic coupler is provided in FIGS. 6a, 6b, and 6c. The electronic coupler-receiving portion 314 may have a C-channel shape that may accommodate and securely hold onto the electronic coupler plugged into a communication port on a circuit board.

The tab engaging portion 308 may extend substantially perpendicular from the second wall 304. The tab engaging portion 308 may act as a wedge-shaped protruding member for an inner portion of the electronic coupler-receiving portion 314. The tab engaging portion 308 may be configured to engage with a locking tab of the electronic coupler (see FIGS. 6a, 6b, and 6c) when the electronic coupler is positioned at least partially within the electronic coupler-receiving portion 314. In cases where the electronic coupler is held within the electronic coupler-receiving portion 314, the tab engaging portion 308 may contact the locking tab and may be maneuvered to release the locking tab from a locked state to an unlocked state.

In accordance with an embodiment, the electronic coupler removal tool 300 may further include a stopper wall 316. The stopper wall 316 may extend substantially perpendicular from the second wall 304. The stopper wall 316 may be configured to facilitate positioning of the electronic coupler within the electronic coupler-receiving portion 314. The stopper wall 316 may be of a suitable strength and shape to provide an adequate support for removal of the electronic coupler, without causing any damage to a cable and/or the electronic coupler. The stopper wall 316 and the third wall 306 may be carefully placed to leave an adequate clearance in order to accommodate different electronic couplers whose sizes vary within a certain size range. In certain embodiments, the stopper wall 316 and the third wall 306 may be carefully placed to provide an interference fit with an outer profile of the electronic coupler.

The third wall 306 and the tab engaging portion 308 may be separated by a distance 318. The distance 318 may be less than a distance 320 between the second wall 304 and the third wall 306. The distance 318 may determine a maximum size of the electronic coupler that may be accommodated within the electronic coupler-receiving portion 314. The stopper wall 316 and the third wall 306 may help to lift up the electronic coupler once the tab engaging portion 308 disengages the locking tab, which is usually provided in the electronic coupler for a secure connection into the circuit board port. The electronic coupler may be one of a straight electronic coupler or a double straight electronic coupler.

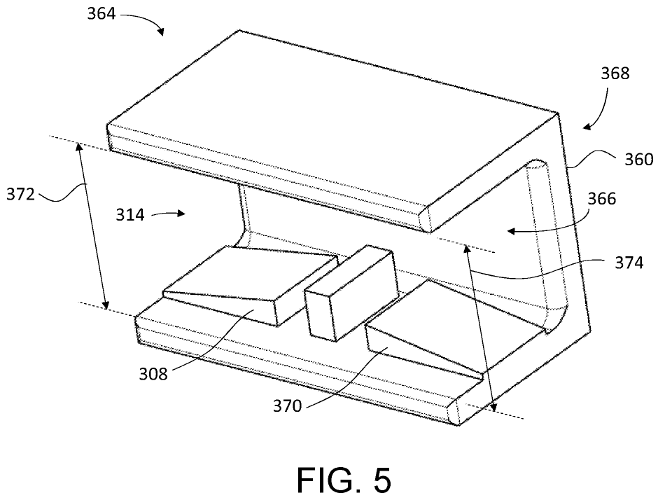

FIG. 5 illustrates a perspective view of an alternative embodiment 360 of the second electronic coupler removal tool 300 (shown in FIG. 4). The electronic coupler removal tool 360 is also configured for removing a straight electronic coupler. In the alternative embodiment, the electronic coupler removal tool 360 includes a first electronic coupler-receiving portion, for example, electronic coupler-receiving portion 314 (also shown in FIG. 4), positioned at a first end 364 of the electronic coupler removal tool 360. Furthermore, the electronic coupler removal tool 360 includes a second coupler-receiving portion 366 positioned at a second end 368 of the electronic coupler removal tool 360. The electronic coupler removal tool 360 includes a first tab engaging portion, for example, tab engaging portion 308 (also shown in FIG. 4), and a second tab engaging portion 370. The electronic coupler removal tool 360 functions in substantially the same manner as the electronic coupler removal tool 300, however, the electronic coupler removal tool 360 is capable of removing two sizes of electronic couplers. For example, a width 372 of first electronic coupler-receiving portion 314 may be different from a width 374 of second coupler-receiving portion 366. The sizes of first tab engaging portion 308 and second tab engaging portion 370 may also be different to facilitate removal of two different sizes of electronic couplers.

FIGS. 6a, 6b, and 6c, collectively, illustrate a sequence of operations performed using the electronic coupler removal tool of FIG. 4 for removal of an electronic coupler from a circuit board port, in accordance with an embodiments of the disclosure. With reference to FIGS. 6a, 6b, and 6c, there is shown a sequence of operations performed using the electronic coupler removal tool 300 for removal of an electronic coupler 400 from a circuit board port 402. In FIGS. 6a, 6b, and 6c, the electronic coupler 400 is a straight-angled electronic coupler that has a specific design. However, the disclosure may not be so limited and in some embodiments, the design of the electronic coupler 400 may be different from the one that has been illustrated in FIGS. 6a, 6b, and 6c, without a deviation from scope of the disclosure.

With reference to FIG. 6a, the electronic coupler 400 may be typically installed within the circuit board port 402 of a circuit board 404. Examples of the electronic coupler 400 may include, but are not limited to, a MOST bus coupler, an RES coupler, and/or a Fakra connector. The circuit board port 402 may correspond to a communication port for an in-vehicle network and/or a vehicle-to-everything (V2X) communication network. The electronic coupler 400 may be plugged and locked into the circuit board port 402 provided on the circuit board 404 using a locking tab 406 coupled to the electronic coupler 400. Initially when the electronic coupler 400 is plugged into the circuit board port 402, the locking tab 406 may be biased in a locked state and may be configured to secure the electronic coupler 400 to the corresponding circuit board port 402 when in the locked state.

With reference to FIG. 6b, there is shown a maneuver to place the electronic coupler removal tool 300 such that the electronic coupler 400 is at least partially held within the electronic coupler-receiving portion 314 of the electronic coupler removal tool 300. In some embodiments, the electronic coupler 400 may include a first coupler end 400a having a first size and a second coupler end 400b having a second size. The first size may be different from the second size. In such a case, the electronic coupler-receiving portion 314 may engage with the electronic coupler 400 at the first coupler end 400a and the second coupler end 400b.

The electronic coupler-receiving portion 314 of the electronic coupler removal tool 300 may be coaxially aligned with the electronic coupler 400 mounted on the circuit board port 402. Thereafter, the electronic coupler-receiving portion 314 may be moved in first direction 208 to slide over an exterior profile of the electronic coupler 400 such that the tab engaging portion 308 contacts the locking tab 406. Distance 318 is selected to hold locking tab 406 in an unlocked state when the electronic coupler 400 is positioned within electronic coupler-receiving portion 314.

The electronic coupler 400 may be restrained within the electronic coupler-receiving portion 314 via the tab engaging portion 308. In such a case, the electronic coupler 400 may be removably attached to the tab engaging portion 308. More specifically, the electronic coupler 400 may be held in a grip of the tab engaging portion 308 such that the tab engaging portion 308 engages with the locking tab 406 of the electronic coupler 400. Once the tab engaging portion 308 engages the locking tab 406 of the electronic coupler 400, the locking tab 406 may be released from the circuit board port 402. For example, a squeezing action from the sides of the second wall 304 and the third wall 306 may be applied to maintain the position of electronic coupler 400 within the electronic coupler-receiving portion 314 during separation of the electronic coupler 400 from the circuit board port 402. Typically, the circuit board port 402 may include a groove to receive the locking tab 406.

With reference to FIG. 6c, there is shown a maneuver performed using the electronic coupler removal tool 300 to remove the restrained electronic coupler 400 from the circuit board port 402. This may be performed once the locking tab 406 is released from the circuit board port 402. For the maneuver, the restrained electronic coupler 400 may be pulled in the second direction 212 relative to the circuit board port 402 to remove the electronic coupler 400 from the circuit board port 402. In this case, the second wall 304 and the third wall 306 may act as grip members to maneuver the restrained electronic coupler 400 for removal from the corresponding circuit board port 402. While pulling the electronic coupler removal tool 300 along with the electronic coupler 400 in the second direction 212, the stopper wall 316 may engage with the electronic coupler 400 via the interlocking element 408. Further, the stopper wall 316 may provide a support to the electronic coupler 400 during the removal of the electronic coupler 400 from the circuit board port 402. The stopper wall 316 may be of suitable strength and shape to provide adequate support to the electronic coupler 400 during removal. The C-channel shape of the electronic coupler-receiving portion 314 may allow a cable 410 connected to the electronic coupler 400 to remain free from any restrain and damage.

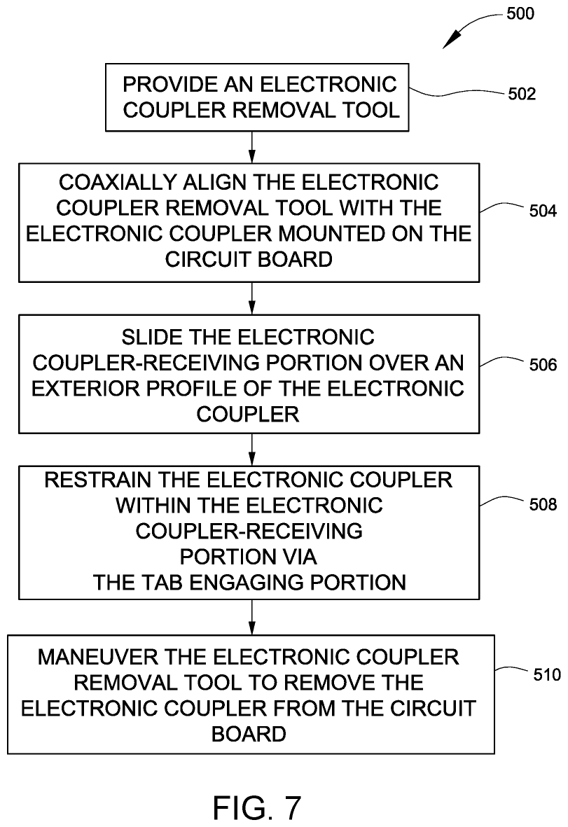

FIG. 7 is a flowchart that illustrates an exemplary method for removal of an electronic coupler from a circuit board using an electronic coupler removal tool, in accordance with an embodiment of the disclosure. With reference to FIG. 7, there is shown a flowchart 500 that depicts a method for the removal of the electronic coupler (200, 400) from the circuit board port (202, 402). The method performed using the electronic coupler removal tool (100, 260, 300) may start at 502. The following description may be explained in conjunction with the drawings and detailed descriptions of the preceding figures.

At 502, the electronic coupler removal tool (100, 260, 300, 360) for removal of the electronic coupler (200, 400) is provided. At 504, the electronic coupler-receiving portion (114, 314, 366) may be coaxially aligned with the electronic coupler (200, 400) mounted on the circuit board (204, 404). At 506, the electronic coupler-receiving portion (114, 314, 366) may slide over an external profile of the electronic coupler (200, 400). In some embodiments, the exterior profile of the electronic coupler (200, 400) may include an interlocking element 408 that may be configured to detachably attach the electronic coupler (200, 400) to the tab engaging portion (108, 262, 308, 370).

At 508, the electronic coupler (200, 400) may be restrained within the electronic coupler-receiving portion (114, 314, 366) via the tab engaging portion (108, 262, 308, 370). The tab engaging portion (108, 262, 308, 370) may engage with the locking tab (206, 406) to release the electronic coupler (200, 400) from the circuit board (204, 404). At 510, the electronic coupler removal tool (100, 260, 300, 360) may be maneuvered to remove the electronic coupler (200, 400) from the circuit board (204, 404).

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Reference will now be made in detail to specific aspects or features, examples of which are illustrated in the accompanying drawings. Wherever possible, corresponding or similar reference numbers will be used throughout the drawings to refer to the same or corresponding parts.

The foregoing description of embodiments and examples have been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. An electronic coupler removal tool comprising:
a first wall having a first end and a second end;
a second wall positioned at said first end of said first wall and extending substantially perpendicular from said first wall;
a third wall positioned at said second end of said first wall and extending substantially perpendicularly from said first wall,
wherein said first wall, said second wall, and said third wall at least partially define an electronic coupler-receiving portion that is configured to slidably receive an electronic coupler; and
a tab engaging portion that extends substantially perpendicular from at least one of said first wall and said second wall and is configured to engage a locking tab of said electronic coupler when said electronic coupler is positioned at least partially within said electronic coupler-receiving portion.

2. The electronic coupler removal tool according to claim 1, wherein said electronic coupler-receiving portion is shaped to conform to an exterior profile of said electronic coupler.

3. The electronic coupler removal tool according to claim 1, wherein said tab engaging portion and said third wall are separated by a distance, and wherein said distance is determined such that said locking tab of said electronic coupler is held in an unlocked state when said electronic coupler is positioned between said second wall and said third wall.

4. The electronic coupler removal tool according to claim 1, further comprises a stopper wall that extends substantially perpendicular from at least said first wall, said second wall, and said third wall and is configured to facilitate positioning of said electronic coupler within said electronic coupler-receiving portion.

5. The electronic coupler removal tool according to claim 1, further comprises a cable support portion defined by at least one of said second wall and said third wall, wherein said cable support portion is configured to receive a cable coupled to said electronic coupler.

6. The electronic coupler removal tool according to claim 1, wherein said electronic coupler-receiving portion is rotated away relative to said a circuit board to disengage said electronic coupler from a corresponding circuit board port.

7. The electronic coupler removal tool according to claim 1, wherein said electronic coupler is one of a Media Oriented Systems Transport (MOST) bus coupler, a rear entertainment system (RES) coupler, and a Fakra connector.

8. The electronic coupler removal tool according to claim 1, wherein said electronic coupler is one of a right-angled electronic coupler, a straight electronic coupler, and a double straight electronic coupler.

9. The electronic coupler removal tool according to claim 1, wherein said locking tab of said electronic coupler is biased in a locked state and is configured to secure said electronic coupler to a corresponding circuit board port when in said locked state.

10. The electronic coupler removal tool according to claim 1, wherein said electronic coupler comprises a first coupler end having a first size and a second coupler end having a second size, wherein said first size is different from said second size.

11. The electronic coupler removal tool according to claim 10, wherein said electronic coupler-receiving portion engages with said electronic coupler at said first coupler end and said second coupler end.

12. The electronic coupler removal tool according to claim 1, further comprising a handle that extends from said first wall, wherein said handle is configured to maneuver said electronic coupler for removal from a corresponding circuit board port.

13. A method for removing an electronic coupler, the method comprising:
providing an electronic coupler removal tool comprising:
a first wall having a first end and a second end;
a second wall positioned at said first end of said first wall and extending substantially perpendicular from said first wall;
a third wall positioned at said second end of said first wall and extending substantially perpendicularly from said first wall,
wherein said first wall, said second wall, and said third wall at least partially define an electronic coupler-receiving portion that is configured to slidably receive an electronic coupler; and
a tab engaging portion that extends substantially perpendicular from said second wall and is configured to engage a locking tab of said electronic coupler when said electronic coupler is positioned at least partially within said electronic coupler-receiving portion,
aligning said electronic coupler-receiving portion coaxially with said electronic coupler mounted on a circuit board;
sliding said electronic coupler-receiving portion over an exterior profile of said electronic coupler such that said tab engaging portion contacts said electronic coupler;
restraining said electronic coupler within said electronic coupler-receiving portion via said tab engaging portion; and
maneuvering said electronic coupler removal tool to remove said restrained electronic coupler from said circuit board.

14. The method according to claim 13, wherein said restraining further comprises removably attaching said electronic coupler to said tab engaging portion.

15. The method according to claim 13, wherein said maneuvering further comprises rotating said electronic coupler removal tool with said restrained electronic coupler away from said circuit board to remove said electronic coupler from said circuit board.

16. The method according to claim 13, wherein said maneuvering further comprises pulling said restrained electronic coupler in an upward direction relative to said circuit board to remove said electronic coupler from said circuit board.

17. The method according to claim 13, wherein said exterior profile of said electronic coupler further comprises an interlocking element configured to detachably attach said electronic coupler to said tab engaging portion.

18. The method according to claim 13, said maneuvering further comprises maneuvering said electronic coupler using a handle that extends from said first wall for removal of said electronic coupler from a corresponding circuit board port.

19. The method according to claim 13, wherein said electronic coupler is one of a Media Oriented Systems Transport (MOST) bus coupler, a rear entertainment system (RES), and a Fakra connector.

20. The method according to claim 13, wherein said electronic coupler is one of a right-angled electronic coupler, a straight electronic coupler, and a double straight electronic coupler.
